(19) United States
(12) Patent Application Publication
(10) Pub. No.: US 2023/0162271 A1
(43) Pub. Date: May 25, 2023

(54) METHOD AND SYSTEM FOR REQUESTING SERVICE PROVIDERS IN REAL TIME VIA A SERVICE PROVIDERS WEBSITE OR WEB PORTAL

(71) Applicant: MIAN AHMED, FREMONT, CA (US)

(72) Inventor: MIAN AHMED, FREMONT, CA (US)

(21) Appl. No.: 17/557,106

(22) Filed: Dec. 21, 2021

Related U.S. Application Data
(63) Continuation-in-part of application No. 16/041,408, filed on Jul. 20, 2018, now Pat. No. 11,403,572.

(51) Int. Cl. G06Q 30/0601; G06F 16/9537; G06F 16/9538; G06F 9/54

(52) U.S. Cl. CPC G06Q 30/0639; G06F 16/9537; G06F 16/9538; G06F 9/547; G06Q 30/0631

(57) ABSTRACT

A system and method are disclosed for facilitating communication between a user device and at least one service provider device including automatically displaying, in real-time, the location of the at least one service provider on the user's device without requiring use request input. The system comprises a service request server and at least one database. The service request server is configured to enable a requestor such as customer to seek information on local service providers. The system is further configured to display approved, authentic, and qualified service providers matching the request provided by the requestor within a particular area defined by the requestor or the system.

### CROSS REFERENCE TO RELATED APPLICATIONS

This application claims priority to and is a Continuation-in-Part of U.S. Non-provisional patent application Ser. No. 16/041,408 filed on Jul. 20, 2018, the entire contents of which are hereby incorporated by reference.

### TECHNICAL FIELD

The present invention relates to customer service, and more specifically relates to a system and method for displaying service providers in real time via a subscription-based model.

### BACKGROUND OF THE PRESENT INVENTION

In present day, customers often encounter service repairs like plumbing, electrical, roofing, carpentry, heating and air, house cleaners, repair person solutions, air conditioning, carpet cleaning, appliances, security, CCTV installation, cable and dish installation, furniture repair, landscaper, tree removal, pest control, or many other residential or commercial services. Conventional method employed to connect customers with service providers involves contacting the service provider through their mobile numbers and wait for their arrival, which comprises many drawbacks One problem is that many customers have a challenging time to get a licensed, insured, bonded, reliable, background checked, drug free service providers.

Another problem is that whenever the customer has an emergency break down, they want the service provider to arrive in no time and the service provider claim to be locally available only a few miles away from customer service location and create bogus appearance either on internet or print media using local numbers and inaccurate location information.

Another problem is that many service providers promise an arrival period with the customer, but they do not arrive in that time frame and customers have no means to track when the service provider is arriving or even the service provider is in route or changed mind to not to even come. Hence there is no visibility or track where the service provider is.

Another problem is that the customers get surprised when upon arrival they come to know that the service provider who came to their service location after hours of waiting is hencenot capable to do that job. The service provider or customer did not make clear what type of services customer need and if the service provider who is coming have expertise in performing those services.

Another problem is that most of the review sites do not show accurate reviews about service providers which makes customer confuse about their work ethics, because any one can create account and post unreal reviews in favor of service providers. This makes customers to pick those service providers but after the service is performed in some cases the customer ends up in posting negative feedback.

Another problem is that when the customers get a worse experience from a service provider there is no other service or system that block or prevent those service providers from appearing in front of other customers.

Another problem is that customers after encountering with an emergency break down do not know if the service provider, they are choosing is even ready to fulfill that service request or not. There is no on-line status of the service provider if they are ready to work or not just a profile on-line does not mean a service provider is available.

Service providers may also desire to provide a means to potential customers for tracking of service providers in real time and displaying the location of service providers in real time in a web-based portal or website graphical user interface (GUI). service providers may subscribe to a system that may be utilized to receive service provider technician location details in real time an integrate said location details into a website or web-based portal of the service provider.

Hence, it is necessary to provide service providers and customers with a system that would overcome customer's major objections like getting service technicians estimated time of arrival, identify, and connect with certified, licensed background checked service providers with true positive reviews, track service provider current location while service provider being driving and confirming that the service provider coming to customer location is fully capable of performing that work. The system may also provide an improved means of communicating to potential customers the availability of service providers within their area.

### SUMMARY OF THE PRESENT INVENTION

The present invention teaches a system and method to identify and acquire assistance of a local, clean, professional, real, experienced, service providers in real time.

One aspect of the present invention includes the method for initiating and accepting service request over a network. Another aspect of the present invention includes the method of confirming the availability of service providers via cloud, wireless, wide area network. Another aspect of the present invention includes a method of displaying approved, authentic, qualified service providers in real time within defined radius on a website, web portal, or GUI. Another aspect of invention includes the method of displaying the closest service provider to the service location based upon the performance from a given preference list. Another aspect of the present invention includes the method to locate the service provider exactly according to customer search where the request broadcasts to the defined no of service providers on remote or wired devices via cloud, wireless, wired network system.

Another aspect of the present invention includes providing a web-based GUI or on-demand, real-time visual representation of service provider employees or vehicles in a fixed geographical area. In another embodiment, the invention may include receiving user location data and providing a web-based GUI or on-demand, real-time visual representation of service provider employees or vehicles near the user location.

Other objects, features and advantages of the present invention will become apparent from the following detailed description. It should be understood, however, that the detailed description and the specific examples, while indicating specific embodiments of the present invention, are given by way of illustration only, since various changes and modifications within the spirit and scope of the present invention will become apparent to those skilled in the art from this detailed description.

### BRIEF DESCRIPTION OF THE DRAWINGS

The accompanying drawings, which are incorporated herein and form a part of the specification, illustrate the present invention and, together with the description, further serve to explain the principles of the present invention and to enable a person skilled in the pertinent art to make and use the present invention.

The embodiments herein will be better understood from the following detailed description with reference to the drawings, in which

FIG. 1 illustrates an environment implemented in accordance with various embodiments of the present invention.

FIG. 2 illustrates a block diagram of a service request server, according to an embodiment of the present invention.

FIG. 3 illustrates a method for requesting service providers in real time, according to an embodiment of the present invention.

FIG. 4 illustrates a process flow of the customer, according to an embodiment of the present invention.

FIG. 5 illustrates a process flow of the service provider, according to an embodiment of the present invention.

FIG. 6 illustrates a process flow of the service provider associated with a company, according to an embodiment of the present invention.

FIG. 7 illustrates an example GUI of a service provider's website depicting on-demand, real-time visual representation of service provider employees or vehicles near a user location.

FIG. 8 illustrates an example GUI of a service provider's website depicting on-demand, real-time visual representation of service provider employees or vehicles near a predetermined location

FIG. 9 illustrates an example GUI of a service provider's website depicting on-demand, real-time visual representation of service provider employees or vehicles near a predetermined location.

### DETAILED DESCRIPTION OF THE PRESENT INVENTION

A description of embodiments of the present invention will now be given with reference to the Figures. It is expected that the present invention may be embodied in other specific forms without departing from its spirit or essential characteristics. The described embodiments are to be considered in all respects only as illustrative and not restrictive. The scope of the present invention is, therefore, indicated by the appended claims rather than by the foregoing description. All changes that come within the meaning and range of equivalency of the claims are to be embraced within their scope.

The present invention discloses a system and method for requesting a service provider in real time. The system enables a requestor such as a customer or a user requiring service providers to connect with a preferred service provider.

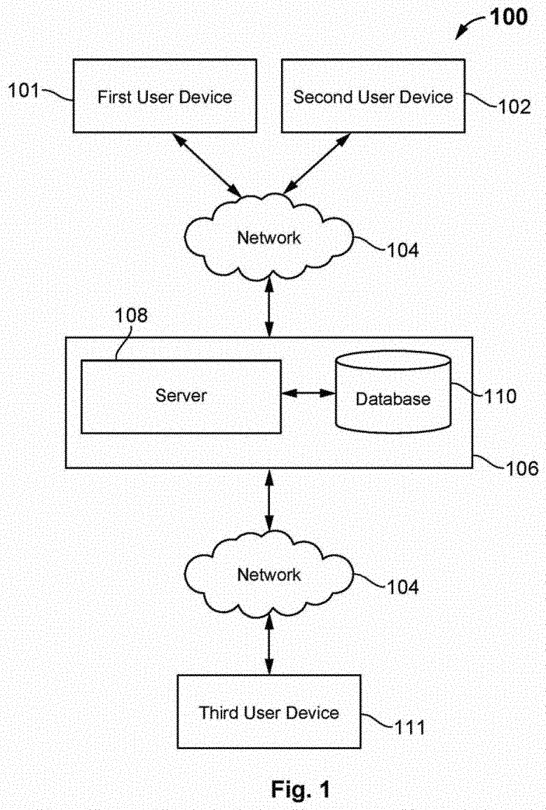

Referring to FIG. 1, a block diagram of an environment 100 implemented in accordance with various embodiments of the present invention is disclosed. The environment 100 comprises a first user device 101 associated with a first user, a second user device 102 associated with a second user, a third user device 111 associated with a third user, a network 104, and a web-based service request system 106 connecting service provider with the customer. In an embodiment, the service request system 106 comprises a service request server 108 and at least one database 110.

In an embodiment, the first user device 101, second user device 102 and third user device 111 are enabled to access the service request system 106 via the network 104. In an embodiment, the first user is a customer seeking service provider details such as availability, proximity, and the like. In an embodiment, the second user is a service provider or technician providing service. In an embodiment, the third user is a company service provider or service provider associated with the company, such as a service providing company server, website, or web portal. In one embodiment, the service request server 108 is configured to enable the requestor to provide a request for service. The request includes type of service required and location where service is required. The server 108 is further configured to display approved, authentic, and qualified service providers matching the request provided by the requestor, within a particular area defined by the requestor. The server 108 is further configured to provide a notification of the request to accept or deny the request. The server 108 is configured to receive service company details, including a subscription to the system, and communicate with various first, second, and third devices to display service provider personnel or vehicle positions on a company web dashboard or GUI. In some embodiments, the server 108 may be constructed and arranged to automatically detect the geographical location of the first user device 101, second user device 102, and third user device 111 and compile in compile geographical location data to assemble a map depicting service provider personnel and vehicles within a predetermined proximity of the first user device or second user device. The server 108 is further configured to connect the service provider and the requestor on acceptance of the request. The server 108 is further configured to process invoice on completion of service by the service provider.

In an embodiment, the user device (101, 102, 111) is in communication with the network 104 to access the service request server 108. In an embodiment, the network 104 could be Wi-Fi network, WiMAX network, and wireless local area network. In one embodiment, the user device (101, 102, 111) is at least anyone of a desktop, a laptop, a tablet, a mobile phone, mobile and/or handheld electronic devices, personnel digital assistants, smart phones, smart televisions, palm tops and phablets.

In one embodiment, the at least one database 110 may be accessible by the service request server. The database 110 may be integrated into the service request server or separate from it. In some embodiments, the database 110 resides in a connected server or in a cloud computing service. Regardless of location, the database 110 comprises a memory to store and organize certain data for use by the service request server 108. In some embodiments, the database 110 stores information relating to a customer, service provider and company operated service provider. In some embodiment, the database 110 stores information relating to service vehicle location which may be systematically or routinely updated such that when a customer user accesses a service provider website, a GUI or map style interface may display on-demand, real-time location data of service provider personnel or vehicles. The database 110 comprises information to identify the customer, service provider and the company, types of service such as plumbing, electrical, roofing, carpentry, heating and air, maids, handyman solutions, air conditioning, carpet cleaning, appliances, security, CCTV installation, cable and dish installation, furniture repair, landscaper, tree removal, pest control, and other residential and commercial services, map data and payment data.

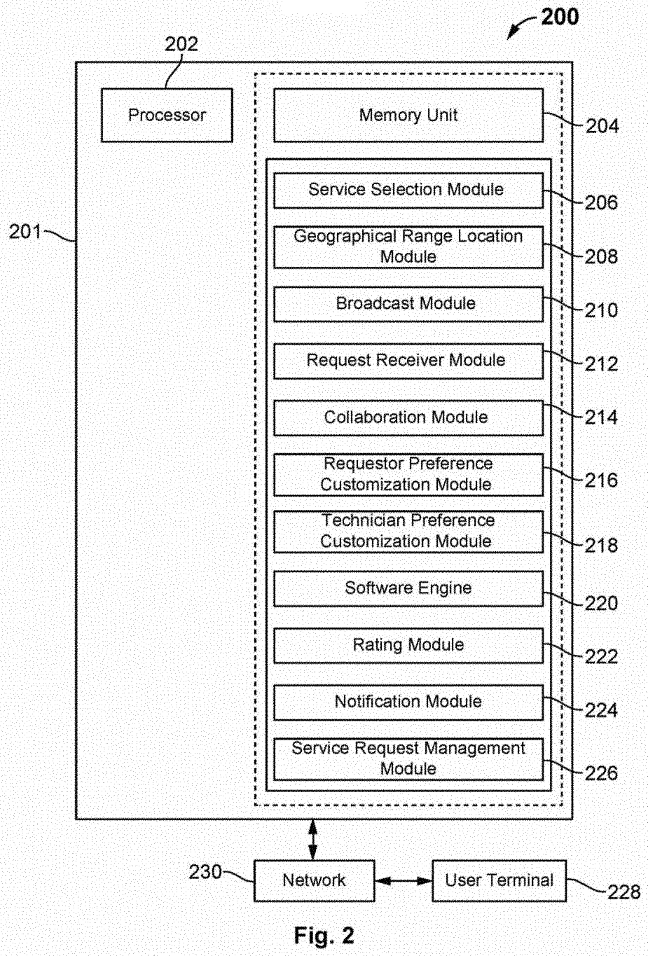

FIG. 2 is a block diagram 200 of the service request server 201 in an embodiment of the present invention. The server 201 comprises a processor 202 and a memory unit 204. The memory unit 206 comprises a set of program modules comprising a service selection module 206, a geographical range location module 208, a broadcast module 210, a request receiver module 212, a collaboration module 214, a requestor preference a customization module 216, a technician preference customization module 218, a software engine 220 and a rating module 222.

In one embodiment, a user access server 201 via a user terminal 228 via a network 230. In some embodiments, the network 230 is at least anyone of a Wi-Fi network, WiMAX network, and wireless local area network. In some embodiments, the user terminal 228 is at least anyone of a desktop, a laptop, a tablet, a mobile phone, mobile and/or handheld electronic devices, personnel digital assistants, smart phones, smart televisions, palm tops and phablets. In an embodiment, the user is requestor or customer, service provider or service technician, or service provider associated with the company. In one embodiment, the server 201 is configured to connect service provider and customer in real-time. The service selection module 206, executed by the processor 202, is configured to enable the requestor to provide a request for a service, wherein the request includes a type of service required, preferred service technician, date, and time, and customer specified location where the service need to be performed. Further, the service selection module 206 is configured to enable the requestor to select preferences such as licensed service provider, insured service provider, bonded service provider, certified service provider, or screened service provider or service provider without license. In one embodiment, the system further provides details of the service provider such as number of service provider in the requestor specified location, estimated time of arrival (ETA) of the service provider and distance between the service provider and the requestor before selection of the request. In another embodiment, the system enables the requestor to

The geographical range location module 208, executed by the processor 202, is configured to locate one or more service provider matching the request provided by the requestor within a particular area relative to the preferred location. The server 201 starts searching the appropriate service provider and finds exact match using customer provided information. According to some embodiments, requests may include customer provided information that may include customer geographical data including the GPS coordinates of the customers smart device, computer, or the like. According to some embodiments, the system may automatically retrieve user location data when a user device accesses the company the website, web portal, or web-based software application without input from a user. According to some embodiments, the system may include it means for user input such as a clickable button within the GUI, or fillable GUI-based field to provide the system with user permission to retrieve user location data. According to some embodiments, the system may allow user input to include a target service location. The server 201 may be constructed and arranged to systematically retrieve customer geographical data from the customers smart device automatically, thereby increasing the efficiency by which the system may also retrieve information relating to service provider geographical data. In this way, the server 201 miss automatically retrieve customer geographical data from the customer smart device without the need for user input via the user's smart device. In one [symbol] one or more service provider includes a company operated service providers.

The broadcast module 210 in communication with the geographical range location module 208, executed by the processor 202, is configured to broadcast the request to the one or more service provider for specific period of time. The request receiver module 212, executed by the processor 202, is configured to present or display the broadcasted request to the service provider to accept or to deny the request for a specific period of time. The request receiver module 212 is further configured to enable the service technician to accept at least one service request before finishing the ongoing service request.

In one embodiment, if one or more service provider identified is a company operated service providers, the request receiver module 212 displays the service request on company dashboard through software engine 220 for a set defined time to accept or reject the request. If no service provider accepts the service request, the geographical range location module 208 would locate a next set of defined service providers based on the request of the customer and broadcasts the service request via the broadcast module 210. This process continues until any one service provider accepts that service request.

On acceptance of the request, the collaboration module 214, executed by the processor 202, is configured to connect the service provider and the requestor. The collaboration module 214 may be configured to automatically retrieve location data of a user device and to automatically retrieve location data of at least one service provider device within relative proximity of the automatically located user device. The collaboration module 214 may further be constructed and arranged to correlate location data of a user device to the at least one service provider device to determine relative proximity. Relative proximity of user devices and service provider devices may be systematically updated according to a predetermined. Such that the system may deliver on demand data to a user's device. Further, the geographical range location module 208 in communication with the collaboration module 214 is configured to creates a real-time drive route from the service provider current location to the customer service location. Further, the geographical range location module 208 in communication with the collaboration module 214 may be configured to provide real time, on-demand, location information regarding service providers such as displaying, on a smart device, various service providers within the proximity of a user. Further, the geographical range location module 208 is configured to notify the customer about the service provider being in route along with service provider's estimated time of arrival. In one embodiment, the service provider on acceptance of the request, the service provider or she could drive to service location on his or will, which provides the time to clear any ongoing call of the service provider. The server 201 is configured to send notification to the customer via the notification module 224, about which service provider accepted request and gets another notification when service provider gets enroute with the route and drive line on map. The rating module 222, executed by the processor 202, is configured to enable the customer to rate the service provider work confirming the service completion. The software engine 220, executed by the processor 202, is configured to process invoice for the service provided by the service provider.

The requestor preference customization module 216, executed by the processor 202, is configured to enable the requestor to set a first criterion to automatically receive notification respective of one or more service technician on satisfaction of the set first criterion, wherein the first criterion includes preferred month, day, time, and location. For example, if the requestor sets a specific day and time of the month, and if any service provider enters into a location relation to the location specified by the requestor on set time, day of the month, then the server 201 sends notification to the customer about the number of service provider, ETA and distance between the service provider and the requestor specified service location.

The requestor preference customization module 216, executed by the processor 202, is further configured to enable the requestor to set a second criterion to automatically receive notification of one or more service technician on satisfaction of the set second criterion, wherein the second criterion includes preferred service technician and location of the preferred service technician for example, if his or her preferred pro or the one who worked in his/her house in past is in neighborhood or nearby his house, the server automatically send service request to the service provider. If the service provider accepts the request, the system would connect the requestor and the service provider for further proceedings.

The requestor preference customization module 216, executed by the processor 202, is further configured to enable the requestor to set a third criterion to automatically receive notification of one or more service technician on satisfaction of the set third criterion, wherein the third criterion includes preferred types of service the service provider/she wants in future. For example, when the service provider belonging or linked to that particular one or more services enters in the customers neighborhood or set radius of customer specified service location, the server 201 will send the push notification to customer about those service providers being nearby. Then, the customer could connect with the service provide in neighborhood, this could save them a huge time for not waiting someone in any other time and have someone come at the same time.

The service request management module 226, executed by the processor 202, is configured to enable the requestor or service provider to cancel or reschedule the service request while being in-route or during driving. If the requestor reschedules the time, the service provider would receive details of reschedule via a notification module 224. The service provider either could accept the service request or reply back with other time or date based on his or her availability. The response of the service provider is sent to the requestor via the notification module 224. The technician preference customization module 218, executed by the processor 202, is configured to enable the service provider to set preferences to automatically send notification to one or more requestor on entering a particular location. For example, if the service provider enters a particular city or zip code, the server tracks his or her latitude and longitude and send push notifications automatically to customers who want same related services.

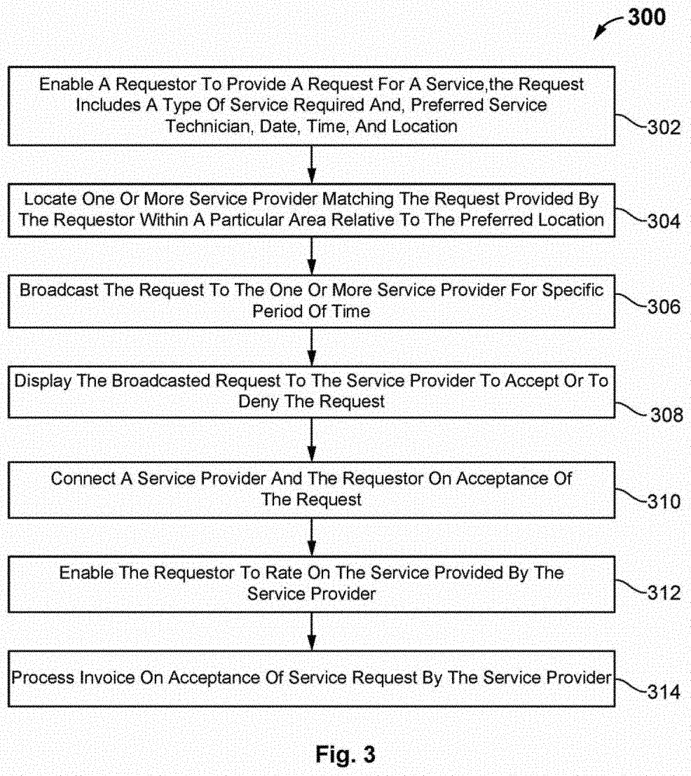

Referring to FIG. 3, a web-based method 300 for requesting service provider in real time is illustrated. In one embodiment, the method 300 is incorporated in the system comprising a server with a processor and a memory unit, a database in communication with the server for storing information related to the service provider, the customer and map data, and a first user device and a second user device configured to access the server via a network. At step 302, the method 300 includes, enabling at the processor, via a service selection module, a requestor to provide a request for a service, wherein the request includes a type of service required and, preferred service technician, date, time, and location. According to various other embodiments, requests may include user device geographical data communicated to the server when a user device access is a service provider's website, web portal, or the like. In this way, request may be automatically communicated to the server such that the system may rapidly locate service provider devices in the relative proximity of the user device in communicate, via displaying on a smart device, the location of service provider vehicles or personnel relative to the user device. At step 304, the method 300 includes, locating at the processor, via a geographical range location module, one or more service provider matching the request provided by the requestor within a particular area relative to the preferred location.

At step 306, the method 300 includes broadcasting at the processor, via a broadcast module in communication with the geographical range location module, the request to the one or more service provider for specific period of time. At step 308, the method 300 includes, displaying at the processor, via a request receiver module, the broadcasted request to the service provider for acceptance or to deny the request. At step 310, the method 300 includes, connecting at a processor, via a collaboration module, the service provider and the requestor on acceptance of the request. At step 312, the method 300 includes, enabling at the processor, via a rating module, the requestor to rate on the service provided by the service provider. At step 314, the method 300 includes processing at the processor, via a software engine, invoice for the service provided by the service provider.

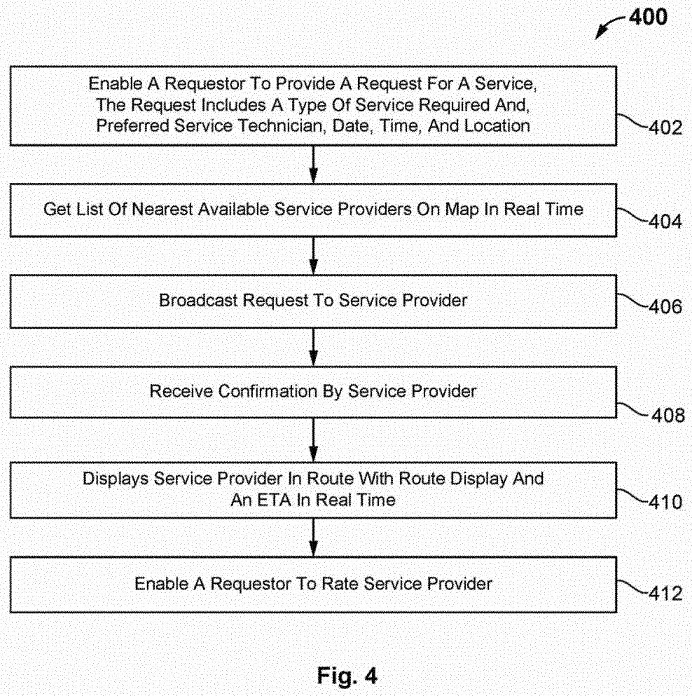

Referring to FIG. 4, a process flow 400 of the customer is illustrated. At step 402, the requestor is enabled to provide a request for a service, the request includes a type of service required and, preferred service technician, date, time, and location. At step 404, a list of nearest available service providers is displayed to the requestor in real time. At step 406, the request is broadcasted to the list of service provider. At step 408, the requestor receives confirmation from at least one service provider. At step 410, the service provider in route with route display and an ETA in real time is displayed to the requestor. At step 412, the requestor is enabled to rate the service provider.

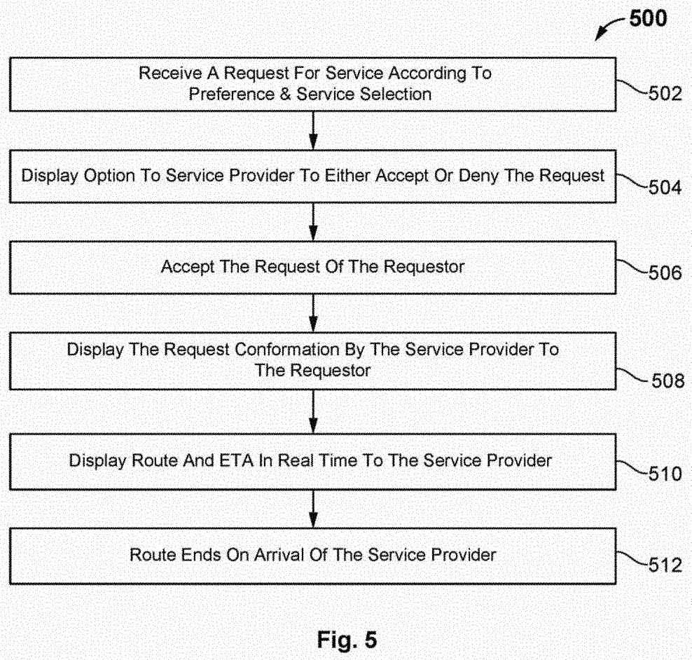

Referring to FIG. 5, a process flow 500 of the service provider is illustrated. At step 502, the service provider receives a request for service according to preference & service selection. At step 504, option to either accept or deny the request is displayed to the service provider. At step 506, the service provider accepts the request. At step 508, the configuration of the request is displayed to the requestor. At step 510, the route and ETA are displayed in real time to the service provider. At step 512, the route ends on arrival of the service provider to the customer specified location.

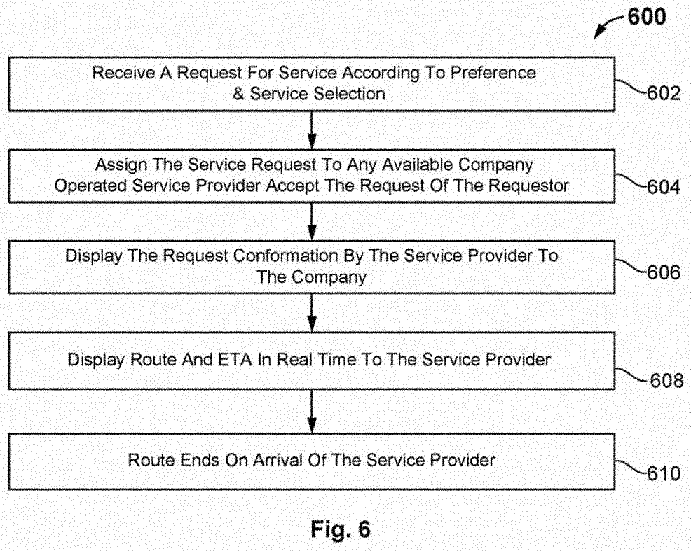

Referring to FIG. 6, a process flow 600 of the service provider associated with a company is illustrated. At step 602, the company receives a request for service according to preference & service selection. At step 604, company assigns the service request to any available company operated service provider accept the request of the requestor. At step 606, the configuration of the request is displayed to the requestor. At step 608, route and ETA are displayed in real time to the service provider. At step 610, the route ends on arrival of the service provider to the customer specified location.

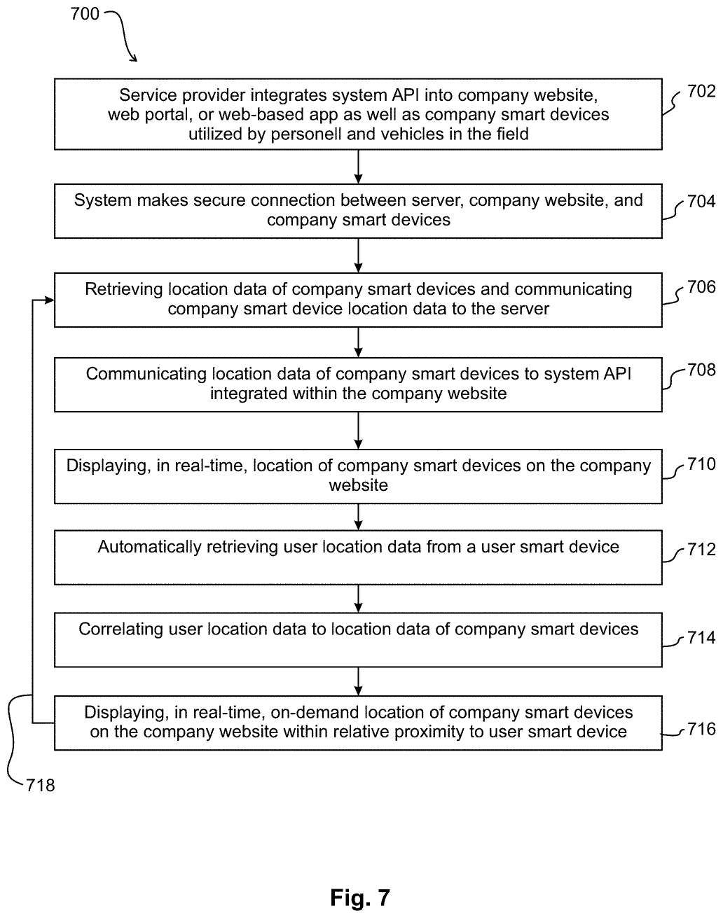

Referring to FIG. 7, a method for implementing a control system for communicating, in real-time, the location data of at least one company smart device and facilitating the communication between the at least one company smart device and a requestor device may include performing actions or steps in various orders. FIG. 7 depicts a simplified diagram of one variation of actions the system may execute to fulfill the method. a system API 700 may execute a number of commands. The commands may include integrating a system API into at least one of a service provider's website, web portal, or web-based software application 702. Integration of the system API may include providing operable communication between a system server, a company website, and various company smart devices utilized by personnel and vehicles in the field. Action 704 may include completing a secure connection between a system server, company website, and various company smart devices. Action 704 may include receiving at least one company smart device information utilized by personnel and vehicles in the field such that the system API may readily locate company smart devices via GPS. Action 706 may include retrieving location data of the at least one company smart device and communicating said location data to the system server. Action 708 may include communicating location data of the at least one company smart device to the system API integrated within the at least one service provider's web site, web portal, or web-based software application. action 710 may include displaying in real time the location of company smart devices on the company website. Action 712 may include automatically, or through input of a user, retrieving user location data from a user smart device. action 714 may include correlating user location data with location data of company smart devices based on at least one predetermined criteria such as proximity. Action 716 may include displaying, in real time, on-demand, real-time location data of company smart devices on the at least one service provider's website, web portal, or web-based software application within relative proximity to the user device. action 718 may include periodically updating retrieved location data of company smart devices 706, communicated location data of company smart devices to the server 708, displayed location of company smart devices 710, retrieved user location data 712, correlated user location data and location data of company smart devices 714, or displayed real time on demand location of company smart devices 716 such that the system API may depict on demand real time location of service provider devices, personnel come over vehicles on. a service provider's website, web portal, or web-based software application.

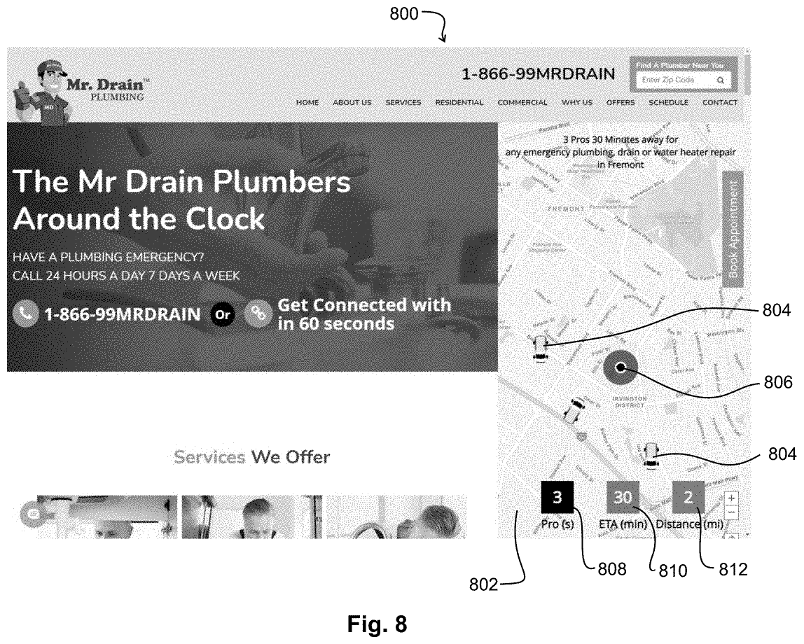

Referring to FIG. 8, the method may include a system API 800 integrated with a website, web portal, or web-based software application to provide a GUI on a smart device such as a smart phone or personal computer depicting relative proximity of potential service providers. According to some embodiments, the system may request user location data when a user device accesses the company the website, web portal, or web-based software application. The GUI may depict a map 802, a user device location 806, and various service provider personnel or vehicle locations 804. The GUI may further communicate number of service providers 808 in relative proximity to the user device, estimated time of arrival 810 of the nearest service provider 804, an estimated distance 812 of the nearest service provider 804.

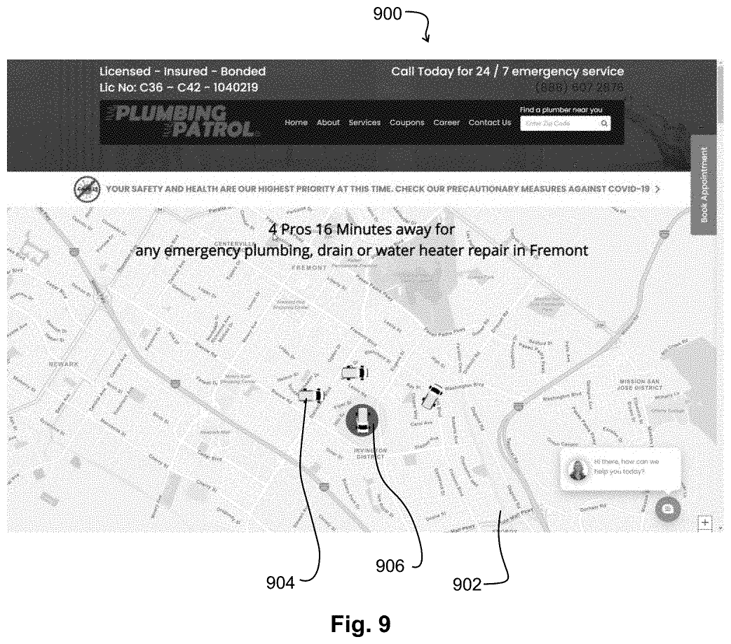

Referring to FIG. 9, the method may include a system API 900 integrated with a website, web portal, or web-based software application to provide a GUI on a smart device such as a smart phone or personal computer depicting relative proximity of potential service providers. According to some embodiments, the system may automatically retrieve user location data when a user device accesses the company the website, web portal, or web-based software application without input from a user. As depicted in FIG. 9, the system may provide a map style depiction of user device location and service provider locations on a website landing page. The GUI may depict a map 902, a user device location 906, and various service provider personnel or vehicle locations 904.

Although a single embodiment of the present invention has been illustrated in the accompanying drawings and described in the above detailed description, it will be understood that the present invention is not limited to the embodiment developed herein, but is capable of numerous rearrangements, modifications, substitutions of parts and elements without departing from the spirit and scope of the present invention.

Having thus described exemplary embodiments of the present invention, it should be noted by those skilled in the art that the within the present invention teaches are exemplary only, and that various other alternatives, adaptations, and modifications may be made within the scope of the present invention. Merely listing or numbering the steps of a method in a certain order does not constitute any limitation on the order of the steps of that method. Many modifications and other embodiments of the present invention will come to mind to one skilled in the art to which this invention pertains having the benefit of the teachings presented in the foregoing descriptions. Although specific terms may be employed herein, they are used only in generic and descriptive sense and not for purposes of limitation. Accordingly, the present invention is not limited to the specific embodiments illustrated herein.

The following description of variants is only illustrative of components, elements, acts, products, and methods considered to be within the scope of the invention and are not in any way intended to limit such scope by what is specifically disclosed or not expressly set forth. The components, elements, acts, products, and methods as described herein may be combined and rearranged other than as expressly described herein and are still considered to be within the scope of the invention.

According to variation 1, a method for handling a service request may include implementing a control system for communicating, in real-time, the location data of a service provider and facilitating the communication between the service provider and a requestor, the control system including a server, a processor, and a memory unit; database in communication with the server for storing information related to the service provider, the requester, map data, and proximity data relating to the location of the service provider relative to the requestor; a requester device associated with the requestor including a first display configured to access the server via a network, and a service provider device associated with the service provider including a second display configured to access the server via a network, wherein the memory unit stores an application including a set of program modules; and wherein the processor, in communication with the memory unit, is configured to execute the set of program modules to communicate over the network with the requestor device and the service provider device, and further configured to provide output in response to communications received from the control system that are related to location data; including: receiving at the server a service request from the requestor device; automatically determining the location of the requester device; locating at least one service provider device; determining proximity of the service provider device relative to the requestor device; correlating the requestor device to the service provider device dependent on predetermined proximity criteria; displaying on the first display, the real-time location of at least one nearby service provider relative to the location of the requester device; displaying, in real-time, on the first display, the located at least one service provider device within the particular area within the requestor's proximity including at least one service provider device estimated time of arrival and distance from the requestor device; displaying on the second display, a service request notification includes service date, time, or location; receiving, within said predefined time, at the server an indication from the at least one service provider device to accept the request; creating a real-time drive route from a current location of the service provider device to a service location; displaying on a map-style graphical user interface on the second display of the service provider device, the real-time drive route from the current location of the service provider device to the service location and the estimated arrival time; receiving service provider acceptance of the service request within a predetermined period of time; sending at least one notification in real-time to the requestor device when the service provider device is moving toward the service location; sending tracking information to the requestor device to track in real-time a current location of the service provider device while the service provider device advances to the service location; and displaying on a map-style graphical user interface on the first display of the requestor device, the real-time current location of the service provider device, distance from the requestor device to the service provider device, and estimated arrival time.

Variation 2 may include a method as in variation 1, wherein the processor and the program modules are further configured to provide a route to the service provider device in real-time to reach the location specified by the requester device.

Variation 3 may include a method as in any of variations 1 through 2, wherein the processor in the program modules are further configured to locate a new set of one or more service provider devices within said particular area within a requestors proximity if the server does not receive set indication from the service provider device to accept the request within the predefined time.

Variation 4 may include a method as in any of variations 1 through 3, wherein the predetermined proximity criteria include a system determined radial proximity relative to the user device.

Variation 5 may include a method as in any of variations 1 through 4, wherein the predetermined proximity criteria include a user determined radial proximity relative to the user device.

Variation 6 may include a method as in any of variations 1 through 5, wherein the processor and the program modules are further configured to enable the requestor device to set a first criterion to automatically receive notification respective of one or more service provider on satisfaction of the set first criterion, where in the first criterion includes preferred month, day, time and location; and enable the requestor device to set a second criterion to automatically receive notification of one or more service provider on satisfaction of the set second criterion, wherein the second criterion includes preferred service provider and location of the preferred service provider.

Variation 7 may include a method as in any of variations 1 through 6, wherein the processor and the program modules are further configured to enable a service provider device to automatically send notification to one or more requester device on entering a particular location.

Variation 8 may include a method as in any of variations 1 through 7, wherein the processor and the program modules are further configured to enable the requester device and/or the service provider device to change, in real-time, a scheduled request, cancelled the request, cancelled the accepted request by the service provider, and change a schedule of the accepted request.

Variation 9 may include a method as in any of variations 1 through 8, wherein the processor and the program modules are further configured to send notifications in real-time to the requestor device and/or the service provider device on changes in schedule, cancellation of request, acceptance of request and cancellation of accepted request.

According to variation 10, a method for implementing a control system for communicating, in real-time, the location data of at least one company smart device and facilitating the communication between the at least one company smart device and a requestor device, the control system including a server, a processor, and a memory unit, the control system being constructed and arranged for executing commands of a system API. The commands may include integrating a system API into at least one of a service provider's website, web portal, or web-based software application; receiving at least one company smart device information utilized by personnel and vehicles in the field such that the system API may readily locate company smart devices via GPS; securely connecting the server, the at least one service provider's web site, web portal, or web-based software application, and at least one company smart device; retrieving location data of the at least one company smart device; communicating said company smart device location data to the server; communicating location data of the at least one company smart device to the system API integrated within the at least one service provider's website, web portal, or web-based software application; automatically retrieving user location data from a user smart device; correlating user location data with location data of company smart devices based on at least one predetermined criteria; displaying, in real time, on-demand location data of company smart devices on the at least one service provider's website, web portal, or web-based software application within relative proximity to the user device; and periodically updating retrieved location data of company smart devices, communicated location data of company smart devices to the server, displayed location of company smart devices, retrieved user location data, correlated user location data and location data of company smart devices, or displayed real time on demand location of company smart devices.

Variation 11 may include a method as in variation 10, further including automatically retrieving user location data from a user smart device such as, but not limited to, when a user smart device accesses the company website.

Variation 12 may include a method as in any of variations 10 through 11, wherein user smart devices utilize a software application dedicated to the system that constructed and arranged communicate user location data to at least one of the server or system API.

Variation 13 may include a method as in any of variations 10 through 12, wherein predetermined criteria include at least one of relative proximity of at least one company smart device to user location, service provider availability, or service provider service type.

Variation 14 may include a method as in any of variations 10 through 13, wherein the predetermined proximity criteria include a system determined radial proximity relative to the user device.

Variation 15 may include a method as in any of variations 10 through 14, wherein the system determined radial proximity relative to the user device is about less than 25 miles.

Variation 16 may include a method as in any of variations 10 through 15, wherein the predetermined proximity criteria include a user determined radial proximity relative to the user device.

Variation 17 may include a method as in any of variations 10 through 16, wherein displaying, in real time, on-demand location data of company smart devices on the at least one service provider's website, web portal, or web-based software application within relative proximity to the user device further includes displaying at least one of number of service providers available, estimated time of arrival of a nearest service provider, or the distance from a user device of the nearest service provider.

Variation 18 may include a method as in any of variations 10 through 17, wherein periodically updating retrieved location data of company smart devices, communicated location data of company smart devices to the server, displayed location of company smart devices, retrieved user location data, correlated user location data and location data of company smart devices, or displayed real time on demand location of company smart devices occurs approximately every three seconds.

Variation 19 may include a method as in any of variations 10 through 18, wherein the at least one company smart device is a plurality of company smart devices associated with distinct service providers.

According to variation 20, a method for facilitating the communication of the location of a plurality of company smart devices between a requestor smart device and a plurality of company smart devices may include implementing a control system including a server, a processor, and a memory unit, the control system being constructed and arranged for executing commands of a system API. The commands may include integrating a system API into at least one of a service provider's website, web portal, or web-based software application; receiving a plurality of company smart devices information utilized by personnel and vehicles in the field such that the system API may readily locate company smart devices via GPS; securely connecting the server, the at least one service provider's website, web portal, or web-based software application, and a plurality of company smart devices over a network; retrieving location data of the plurality of company smart devices; communicating said plurality of company smart devices location data to the server; communicating location data of the plurality of company smart devices to the system API integrated within the at least one service provider's website, web portal, or web based software application; automatically retrieving user location data from a user smart device; correlating user location data with location data of the plurality of company smart devices based on a predetermined radial proximity relative to the user device; displaying, in real time, the location of the plurality of company smart devices on the at least one service provider's website, web portal, or web-based software application; displaying, in real time, on-demand location data of company smart devices on the at least one service provider's website, web portal, or web-based software application within the predetermined radial proximity relative to the user device; and periodically updating retrieved location data of company smart devices, communicated location data of company smart devices to the server, displayed location of company smart devices, retrieved user location data, correlated user location data and location data of company smart devices, or displayed real time on demand location of company smart devices about every three seconds.

Although the present invention has been described in considerable detail with reference to certain preferred versions thereof, other versions are possible. Therefore, the point and scope of the appended claims should not be limited to the description of the preferred versions contained herein.

As to a further discussion of the manner of usage and operation of the present invention, the same should be apparent from the above description. Accordingly, no further discussion relating to the manner of usage and operation will be provided.

With respect to the above description, it is to be realized that the optimum dimensional relationships for the parts of the present invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention. Therefore, the foregoing is considered as illustrative only of the principles of the present invention. Further, since numerous modifications and changes will readily occur to those skilled in the art, it is not desired to limit the present invention to the exact construction and operation shown and described, and accordingly, all suitable modifications and equivalents may be resorted to, falling within the scope of the present invention.

What is claimed is:

1. A method for handling a service request, the method comprising:
implementing a control system for communicating, in real-time, the location data of a service provider and facilitating the communication between the service provider and a requestor, the control system comprising a server, a processor, and a memory unit;
a database in communication with the server for storing information related to the service provider, the requester, map data, and proximity data relating to the location of the service provider relative to the requestor;
a requester device associated with the requestor comprising a first display configured to access the server via a network, and
a service provider device associated with the service provider comprising a second display configured to access the server via a network,
wherein the memory unit stores an application comprising a set of program modules; and
wherein the processor, in communication with the memory unit, is configured to execute the set of program modules to communicate over the network with the requestor device and the service provider device, and further configured to provide output in response to communications received from the control system that are related to location data; comprising:
receiving at the server a service request from the requestor device;
automatically determining the location of the requester device;
locating at least one service provider device;
determining proximity of the service provider device relative to the requestor device;
correlating the requestor device to the service provider device dependent on predetermined proximity criteria;
displaying on the first display, the real-time location of at least one nearby service provider relative to the location of the requester device;
displaying, in real-time, on the first display, the located at least one service provider device within the particular area within the requestor's proximity including at least one service provider device estimated time of arrival and distance from the requestor device;
displaying on the second display, a service request notification comprises service date, time, or location;
receiving, within said predefined time, at the server an indication from the at least one service provider device to accept the request,
creating a real-time drive route from a current location of the service provider device to a service location,
displaying on a map-style graphical user interface on the second display of the service provider device, the real-time drive route from the current location of the service provider device to the service location and the estimated arrival time,
receiving service provider acceptance of the service request within a predetermined period of time;
sending at least one notification in real-time to the requestor device when the service provider device is moving toward the service location;
sending tracking information to the requestor device to track in real-time a current location of the service provider device while the service provider device advances to the service location; and
displaying on a map-style graphical user interface on the first display of the requestor device, the real-time current location of the service provider device, distance from the requestor device to the service provider device, and estimated arrival time.

2. The method of claim 1, wherein the processor and the program modules are further configured to provide a route to the service provider device in real-time to reach the location specified by the requester device.

3. The method of claim 1, wherein the processor and the program modules are further configured to locate a new set of one or more service provider devices within said particular area within a requestors proximity if the server does not receive set indication from the service provider device to accept the request within the predefined time.

4. The method of claim 1, wherein the predetermined proximity criteria comprise a system determined radial proximity relative to the user device.

5. The method of claim 1, wherein the predetermined proximity criteria comprise a user determined radial proximity relative to the user device.

6. The method of claim 1, wherein the processor and the program modules are further configured to:
enable the requestor device to set a first criterion to automatically receive notification respective of one or more service provider on satisfaction of the set first criterion, where in the first criterion includes preferred month, day, time, and location; and
enable the requestor device to set a second criterion to automatically receive notification of one or more service provider on satisfaction of the set second criterion, wherein the second criterion includes preferred service provider and location of the preferred service provider.

7. The method of claim 1, wherein the processor and the program modules are further configured to enable a service provider device to automatically send notification to one or more requester device on entering a particular location.

8. The method of claim 1, wherein the processor and the program modules are further configured to enable the requester device and/or the service provider device to change, in real-time, a scheduled request, cancelled the request, cancelled the accepted request by the service provider, and change a schedule of the accepted request.

9. The method of claim 1, wherein the processor and the program modules are further configured to send notifications in real-time to the requestor device and/or the service provider device on changes in schedule, cancellation of request, acceptance of request and cancellation of accepted request.

10. A method for implementing a control system for communicating, in real-time, the location data of at least one company smart device and facilitating the communication between the at least one company smart device and a requestor device, the control system comprising a server, a processor, and a memory unit, the control system being constructed and arranged for executing commands of a system API, the commands comprising:
integrating a system API into at least one of a service provider's website, web portal, or web-based software application;
receiving at least one company smart device information utilized by personnel and vehicles in the field such that the system API may readily locate company smart devices via GPS;
securely connecting the server, the at least one service provider's website, web portal, or web-based software application, and at least one company smart device;
retrieving location data of the at least one company smart device;
communicating said company smart device location data to the server;
communicating location data of the at least one company smart device to the system API integrated within the at least one service provider's website, web portal, or web-based software application;
automatically retrieving user location data from a user smart device;
correlating user location data with location data of company smart devices based on at least one predetermined criteria;
displaying, in real time, on-demand location data of company smart devices on the at least one service provider's website, web portal, or web-based software application within relative proximity to the user device; and
periodically updating retrieved location data of company smart devices, communicated location data of company smart devices to the server, displayed location of company smart devices, retrieved user location data, correlated user location data and location data of company smart devices, or displayed real time on demand location of company smart devices.

11. A method for handling a service request as in claim 9, further comprising automatically retrieving user location data from a user smart device such as, but not limited to, when a user smart device accesses the company website.

12. A method for handling a service request as in claim 9, wherein user smart devices utilize a software application dedicated to the system that constructed and arranged communicate user location data to at least one of the server or system API.

13. A method for handling a service request as in claim 9, wherein predetermined criteria comprise at least one of relative proximity of at least one company smart device to user location, service provider availability, or service provider service type.

14. A method for handling a service request as in claim 9, wherein the predetermined proximity criteria comprise a system determined radial proximity relative to the user device.

15. A method for handling a service request as in claim 9, wherein the system determined radial proximity relative to the user device is about less than 25 miles.

16. A method for handling a service request as in claim 9, wherein the predetermined proximity criteria comprise a user determined radial proximity relative to the user device.

17. A method for handling a service request as in claim 9, wherein displaying, in real time, on-demand location data of company smart devices on the at least one service provider's website, web portal, or web-based software application within relative proximity to the user device further comprises:
displaying at least one of number of service providers available, estimated time of arrival of a nearest service provider, or the distance from a user device of the nearest service provider.

18. A method for handling a service request as in claim 9, wherein periodically updating retrieved location data of company smart devices, communicated location data of company smart devices to the server, displayed location of company smart devices, retrieved user location data, correlated user location data and location data of company smart devices, or displayed real time on demand location of company smart devices occurs approximately every three seconds.

19. A method for handling a service request as in claim 9, wherein the at least one company smart device is a plurality of company smart devices associated with distinct service providers.

20. A method for facilitating the communication of the location of a plurality of company smart devices between a requestor smart device and a plurality of company smart devices, comprising:
implementing a control system comprising a server, a processor, and a memory unit, the control system being constructed and arranged for executing commands of a system API, the commands comprising:
integrating a system API into at least one of a service provider's website, web portal, or web-based software application;
receiving a plurality of company smart devices information utilized by personnel and vehicles in the field such that the system API may readily locate company smart devices via GPS;
securely connecting the server, the at least one service provider's website, web portal, or web-based software application, and a plurality of company smart devices over a network;
retrieving location data of the plurality of company smart devices;
communicating said plurality of company smart devices location data to the server;
communicating location data of the plurality of company smart devices to the system API integrated within the at least one service provider's website, web portal, or web-based software application;
automatically retrieving user location data from a user smart device;
correlating user location data with location data of the plurality of company smart devices based on a predetermined radial proximity relative to the user device;
displaying, in real time, the location of the plurality of company smart devices on the at least one service provider's website, web portal, or web-based software application;
displaying, in real time, on-demand location data of company smart devices on the at least one service provider's website, web portal, or web-based software application within the predetermined radial proximity relative to the user device; and
periodically updating retrieved location data of company smart devices, communicated location data of company smart devices to the server, displayed location of company smart devices, retrieved user location data, correlated user location data and location data of company smart devices, or displayed real time on demand location of company smart devices about every three seconds.
